(19) United States
(12) Patent Application Publication
(10) Pub. No.: US 2020/0294174 A1
(43) Pub. Date: Sep. 17, 2020

(54) Method for Implementing Ridesharing Between Riders and Drivers

(71) Applicant: Bruce Callahan, Traverse City, MI (US)

(72) Inventor: Bruce Callahan, Traverse City, MI (US)

(21) Appl. No.: 16/553,593

(22) Filed: Aug. 28, 2019

Related U.S. Application Data
(60) Provisional application No. 62/817,606, filed on Mar. 13, 2019.

(51) Int. Cl. G06Q 50/30; G06Q 50/18; G06Q 20/10; G01S 19/39; G01C 21/34

(52) U.S. Cl. CPC G06Q 50/30; G06Q 50/188; G06Q 20/34; G01S 19/39; G01C 21/3407; G06Q 20/10

(57) ABSTRACT

A server ridesharing application system, software application downloadable to a computing device, and method for implementing ridesharing between riders and drivers is disclosed. The ridesharing application system provides a ridesharing application designed to match riders and drivers based on destination and travel date, offering economical travel to riders, and expanding travel choices for many, while simultaneously helping drivers share the expense of a trip with a rider. The system allows riders to enter their travel plans within the application to be matched with a driver that has the same itinerary and enables drivers and riders to agree on a rate that accommodates both parties. Use of the system to share a ride in some cases will cut fuel consumption in half compared to each user taking the trip separately.

### CROSS REFERENCE TO RELATED APPLICATION

The present application is related to and claims priority to U.S. Provisional Patent Application No. 62/817,606 filed Mar. 13, 2019, which is incorporated by reference in its entirety.

### BACKGROUND OF THE INVENTION

The following includes information that may be useful in understanding the present disclosure. It is not an admission that any of the information provided is prior art nor material to the presently described or claimed inventions, nor that any publication or document that is specifically or implicitly referenced is prior art.

### 1. Field of the Invention

The present invention relates generally to the field of mobile applications and more specifically relates to ridesharing applications.

### 2. Description of Related Art

Many riders are priced out of personal transportation options, particularly the elderly. There are many riders who cannot afford to own their own car or simply do not want to. Public transportation is an option for some riders if their destination is on the planned route. Riders that do own a vehicle are limited in ways to share the expense of that purchase. A suitable solution is desired.

U.S. Pat. No. 9,976,863 to David Dryjanski relates to a casual driver ride sharing. The described casual driver ride sharing includes a system for casual driver ride sharing includes an interface and processor. The interface is to receive a request for a ride from a user, wherein the request includes GPS information for the user. The processor is to determine compatibility between the typical route information and the request for the ride; determine a ranked list based at least in part on the compatibility; and provide a ride offer to a driver of the one or more casual drivers based at least in part on the ranked list.

### BRIEF SUMMARY OF THE INVENTION

In view of the foregoing disadvantages inherent in the known mobile applications art, the present disclosure provides a novel method for implementing ridesharing between riders and drivers. The general purpose of the present disclosure, which will be described subsequently in greater detail, is to provide a ridesharing application designed to match riders and drivers based on destination and travel date, offering economical travel to riders, and expanding travel choices for many, while simultaneously helping drivers share trip expenses.

A ridesharing application system and method for implementing ridesharing between riders and drivers is disclosed. The method for implementing ridesharing between riders and drivers includes providing a ridesharing application system including at least one server having a processor, a memory including computer readable instructions that when executed by the processor are configured to recommend multiple ride requests from multiple users, and a software application downloadable to a client-side computing device having a user interface. The users are riders and drivers. The system processes a plurality of trips, each trip defined by a user input via the user interface and comprising an origin, a destination, and a travel time. The system receives information from the driver regarding a desired pickup radius. In some examples, the pickup radius is the maximum desired distance for meeting a rider. The system correlates the driver and the rider based on inputs including origin, destination, travel time, and pickup radius. The method may further include the step of facilitating negotiating a payment between the rider and the driver upon receiving information indicating that the rider and driver have agreed on a trip and a step of identifying the rider or the driver rider based on one or more criteria such as a photograph or verified payment method.

The ridesharing application system provides a ridesharing application for matching riders and drivers based on destination and travel date, offering economical travel to riders. The ridesharing application system also helps drivers share the expense of a trip with riders. The ridesharing application system allows riders to enter their travel plans within the application to be matched with a driver that has the same itinerary and enables drivers and riders to agree on a rate that accommodates both parties.

For purposes of summarizing the invention, certain aspects, advantages, and novel features of the invention have been described. It is to be understood that not necessarily all such advantages may be achieved in accordance with any one embodiment of the invention. Thus, the invention may be embodied or carried out in a manner that achieves or optimizes one advantage or group of advantages as taught without necessarily achieving other advantages as may be taught or suggested. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a method for implementing ridesharing matches between riders and drivers, constructed and operative according to the teachings of the present disclosure.

FIG. 1 is a screen view of a ridesharing application system including a mobile application of a method for implementing ridesharing between riders and drivers during an ‘in-use’ condition, according to an embodiment of the disclosure.

FIG. 2 is a screen view of the mobile application of the method for implementing ridesharing between riders and drivers during an ‘in-use’ condition, according to an embodiment of the disclosure.

FIG. 3 is a screen view of the mobile application of the method for implementing ridesharing between riders and drivers during an ‘in-use’ condition, according to an embodiment of the disclosure.

FIG. 4 is a screen view of the mobile application of the method for implementing ridesharing between riders and drivers during an ‘in-use’ condition, according to an embodiment of the disclosure.

FIG. 5 is a flow diagram illustrating a method for implementing ridesharing between riders and drivers, according to an embodiment of the present disclosure.

The various embodiments of the present invention will be described in conjunction with the appended drawings, wherein like designations denote like elements.

### DETAILED DESCRIPTION

As discussed above, embodiments of the present disclosure relate to a mobile application and more particularly to a method for implementing ridesharing between riders and drivers as used to improve ridesharing.

Generally, the present invention provides a ridesharing application designed to match riders and drivers based on destination and travel date, offering economical travel to riders and expanding travel choices for many, while simultaneously helping drivers share the expense of a trip with a rider. The system allows riders to enter their travel plans within the application to be matched with a driver that has the same itinerary and enables drivers and riders to agree on a rate.

If used, this application will facilitate unacquainted people traveling together, usually in a personal vehicle. The safety and security of both users is important. Part of the information exchanged after each user agrees to give or receive a ride, includes the application displaying the users' photographs in some embodiments. This will prevent the driver from picking up the wrong rider and prevent the rider from getting into the wrong car. Each user must have a credit card or banking record or some secure means of identification to ensure that, while the arrangement will be between unacquainted people, it will not be anonymous. When users select who they want to ride around with, a photograph serves as a good identifier. In some embodiments, identity information, such as the photograph or the bank card or record, is stored with payment information in a rider or driver account in the system. Since this data is verified, when the system provides identification data, the driver or rider can rely on it. This fits into the process of enabling both the driver and the rider to independently verify the other person's identity to help prevent trouble by not removing anonymity of the driver or rider. This lack of anonymity will improve the safety of the participants and will help the transaction proceed smoothly.

Using this system will lower overall fuel consumption. For instance, if two people from a similar geographic area were going to the same location and instead shared the trip, fuel consumption would be cut in half. But without the application, the difficulty in one person locating the other preclude widespread use of this type of informal carpooling.

For purposes of this disclosure, a “recommended trip” is a trip in which the server has correlated a willing driver and a willing rider with similar locations and itinerary. For purposes of this disclosure, a “matched trip” is a recommended trip that the server has verified has been accepted by the rider and the driver. For purposes of this disclosure, an account is any account associated with a rider or driver. For instance, an account includes an account on the system, or an account can refer to a debit, credit, bank, or other account associated with an account on the system.

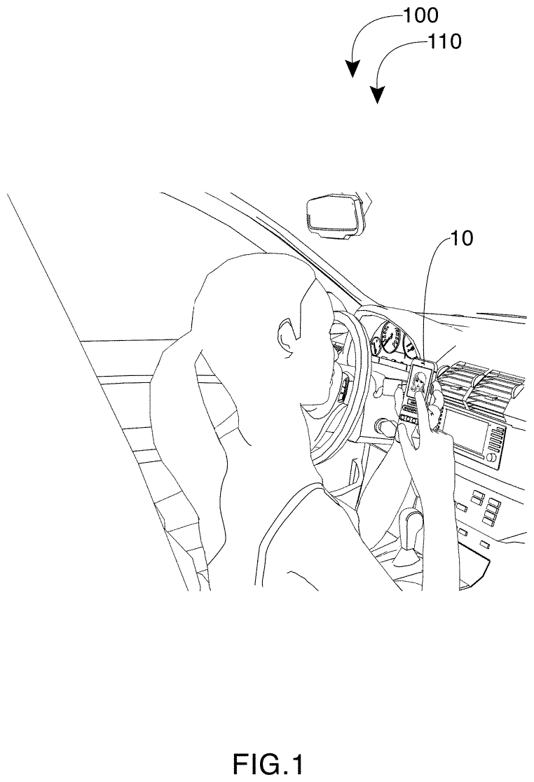

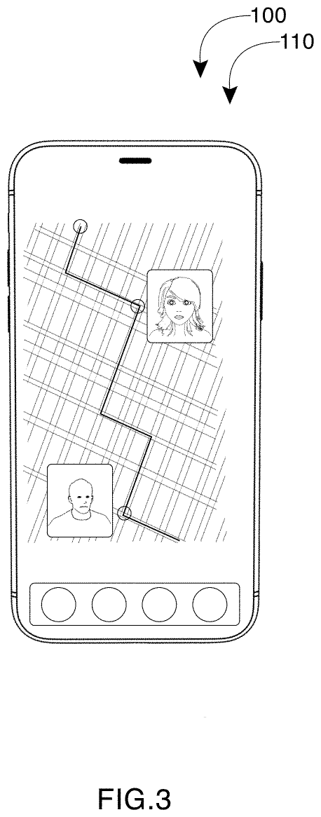

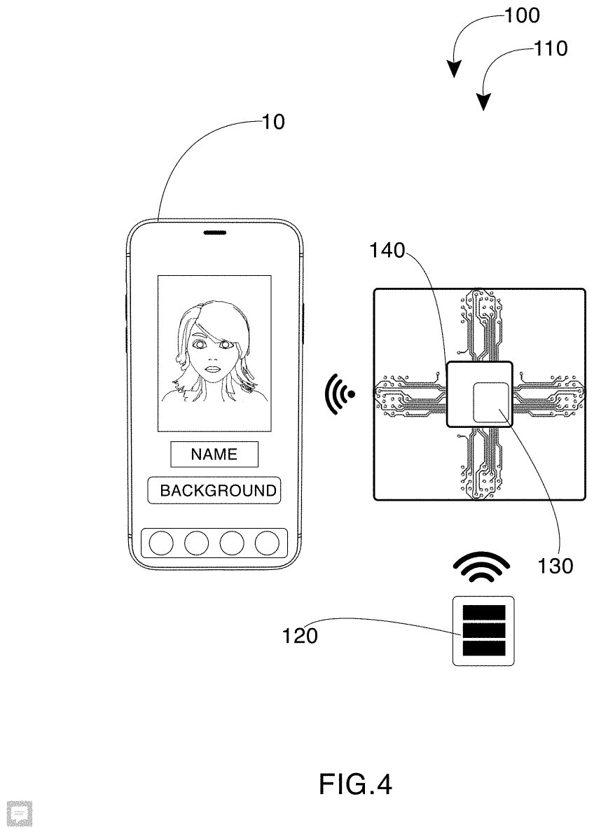

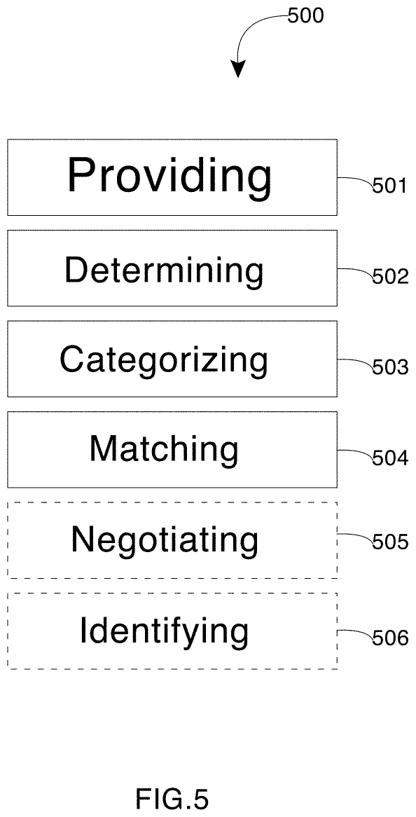

Referring now more specifically to the drawings by numerals of reference, there is shown in FIGS. 1-4, various views of a ridesharing application system 100, a software application 110, and a method for implementing ridesharing recommendations or matches between riders and drivers. As illustrated further in FIG. 5, the method for implementing ridesharing between riders and drivers may comprise the steps of providing a ridesharing application system 100 including at least one server 120 having a processor 130 and a memory 140 including computer readable instructions, that when executed by the processor 130, are configured to match multiple ride requests from multiple users, and a software application 110 downloadable to a client-side computing device 10 having a user interface. The users are riders and drivers. The next step is correlating or calculating a plurality of trips, each trip defined by an origin, a destination, a travel time, and a pickup radius entered via the user interface. Correlating is based on those inputs. The system may further facilitate negotiating a payment between the rider and the driver for a matched trip. In some embodiments, the system facilitates negotiating payment before the system transmits rider identification information to the driver or before the system transmits driver information to the rider.

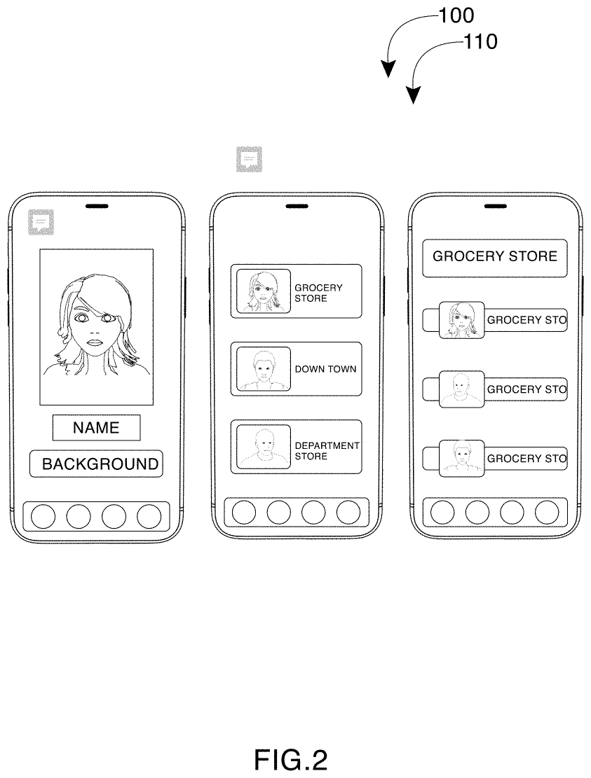

FIG. 2-4 show various screen views of the software application 110 downloadable to a client-side computing device 10 and of the method for implementing ridesharing between riders and drivers of FIG. 1, according to an embodiment of the present disclosure. For purposes of this disclosure, client-side computing devices can be rider client devices, driver client devices, or both. A rider client device is a client-side computing device that processes client instructions that facilitate transmitting a rider request for a trip to the server or that facilitate receiving rider-oriented information from the server. A driver client device is a client-side computing device that processes client instructions that facilitate transmitting a driver offer for a trip to the server or that facilitate receiving driver-oriented information from the server. As before, the ridesharing application system 100 and method for implementing ridesharing between riders and drivers may include at least one server 120 having the processor 130 and the memory 140 including the computer readable instructions that, when executed by the processor 130, are configured to correlate multiple ride requests from multiple users, and a software application 110 downloadable to a client-side computing device 10 having a user interface.

In some embodiments, the system comprises various safety features such as an emergency or help button on the rider or driver client device or client user interface. Alternatively, or in addition to that feature, in some embodiments a remote monitoring station would use information, such as GPS information, from a client device to monitor the location of the vehicle and alarm if the vehicle departs from the calculated route by more than a reasonable amount. In some of these embodiments, a message would be sent to the rider or driver client device allowing them to ensure or to confirm their safety. This message would be silent in some embodiments. In these or other embodiments, an alternative safety process would include monitoring the location of the rider client device and watching the location behavior of the device to ensure that when the rider entered the car the rider client device remained with them. Such a safety device would prevent a driver from picking up the rider and then discarding the rider client device so that the rider couldn't signal for help. As an example, monitoring could include monitoring the rider client device and the driver client device, such as the rider mobile phone and the driver mobile phone and ensure that both devices remain within 10 or 20 feet of each other. This would allow monitoring the safety of both the driver and the rider during the trip. These or other devices would be used to prevent either the driver or the rider from defeating other safety measures built into the ridesharing system.

The application on the driver device or the rider client device can be the same or different. In other words, the application could have an area for entering drive or trip information when a user wanted to offer a drive or trip and also have an area where a user could enter data for requesting a ride in those situations when a ride was desired or wanted. In other versions, the software app may be for the driver and for the rider.

FIG. 5 is a flow diagram illustrating a method for implementing ridesharing between riders and drivers, according to an embodiment of the present disclosure. In particular, the method for implementing ridesharing between riders and drivers 500 may include one or more components or features of the ridesharing application system 100 as described above. As illustrated, the method for implementing ridesharing between riders and drivers 500 may include the steps of step 501, providing a ridesharing application system 100 including at least one server 120 having a processor 130 and a memory 140 including computer readable instructions, a software application 110 downloadable to a client-side computing device 10 having a user interface; step 502, determining a plurality of trips, each trip defined by input from a user via the user interface comprising an origin, a destination, and a travel time; step 503, determining a pickup radius for meeting a rider; step 504, correlating the driver and the rider based on those inputs origin; step 505, negotiating a payment between the rider and the driver upon correlating; and step 506, sending identity data to one or more users based on one or more criteria.

The ridesharing application system 100 automatically collects a base-fee from the payment. The base-fee is a fixed amount deducted from the payment or a variable payment amount deducted from the payment. The computer readable instructions, when executed by the processor 130, may cause a map containing global positioning system (GPS) information to be displayed on the user interface. The map includes a graphical display of the trip including indicators for the inputs of the origin and the destination for both the driver and the rider. The computer readable instructions, when executed by the processor 130, may determine a route for the trip. This route is displayed on the GPS map, in some embodiments.

The method may further include identifying the user based on one or more criteria including a photograph or a verified payment method. The verified payment method may be a validated bank account or credit card. The ridesharing application system 100 monitors the trips taken by the users and records each of the trips on the memory 140. The user interface may allow for providing customized feedback on the ridesharing application system 100. The user interface may allow for providing user ratings. Correlating between the rider and the driver may be completed before the day of the trip or on the day of the trip.

The steps described in the method can be carried out in many different orders according to user preference. The use of “step of” should not be interpreted as “step for”, in the claims and is not intended to invoke the provisions of 35 U.S.C. § 112(f). Under appropriate circumstances, considering such issues as design preference, user preferences, marketing preferences, cost, structural requirements, available materials, technological advances, etc., other methods for implementing ridesharing between riders and drivers, are taught.

The embodiments of the invention described are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A method for implementing ridesharing between riders and drivers comprising the steps of:
providing a ridesharing application system including:
a server having a server processor and a memory containing server instructions that, when executed by the server processor, receive multiple rider requests for a trip, receive multiple driver offers for a trip, calculate recommended trips between the rider requests and the driver offers, and transmit recommended trips to corresponding riders and drivers;
and
a client device having a client processor, a display, and memory containing client instructions that, when executed by the client processor, provide a user interface, and transmit to the server
the rider request for the trip that comprises origin, destination, or trip time information;
or
the driver offer of the trip that comprises origin, destination, trip time, or pickup radius information
executing the client instructions on a rider client device to transmit a rider request;
executing the client instructions on a driver client device to transmit a driver offer;
and
matching a trip by executing server instructions to communicate a matched trip to the driver and the rider after verifying that the rider and the driver accepted the trip.

2. The method of claim 1, further comprising facilitating negotiating a payment between the rider and the driver.

3. The method of claim 2, further comprising deducting a base-fee from the payment wherein the base-fee is a fixed or a variable payment amount deducted from the payment of a rider account or a driver account.

4. The method of claim 3 wherein the ridesharing application system accepts payment from the rider account.

5. The method of claim 4 where the ridesharing application system accepts payment from the driver account 6. The method of claim 1, wherein the rider client device, the driver client device, or both execute client instructions to send GPS information to the display.

7. The method of claim 6, wherein the GPS information includes the origin and the destination for the driver and the rider.

8. The method of claim 7, wherein the server or the client device executes code to calculate route information from the origin to the destination.

9. The method of claim 8, wherein the map information further includes route information.

10. The method of claim 10, further comprising executing server instructions to transmit driver identifying information to the rider client device or to transmit rider identifying information to the driver client device.

11. The method of claim 10, wherein the identifying information includes a photograph.

12. The method of claim 10, wherein the identifying information includes a verified payment method.

13. The method of claim 12, wherein the verified payment method is a credit card.

14. The method of claim 12, wherein the verified payment method is a validated bank account.

15. The method of claim 1, wherein the ridesharing application system records the trips taken by the users.

16. The method of claim 1, wherein the client device executes code that transmits feedback information to the server.

17. The method of claim 1, wherein the client device executes code that transmits user-rating information to the server.

18. The method of claim 1, wherein the system sends or receives information related to matching between the rider and the driver being complete prior to the travel time date.

19. The method of claim 1, wherein the system sends or receives information related to matching between the rider and the driver being complete on the travel time date.

20. A method for implementing ridesharing between riders and drivers comprising the steps of:
providing a ridesharing application system including:
a server having a server processor and a memory containing server instructions that, when executed by the server processor, receive multiple rider requests for a trip, receive multiple driver offers for a trip, calculate recommended trips between the rider requests and the driver offers, and transmit recommended trips to corresponding riders and drivers; and
a client device having a client processor, a display, and memory containing client instructions that, when executed by the client processor, provide a user interface, and transmit to the server
the rider request for a trip that comprises origin, destination, or trip time information
or
the driver offer of the trip that comprises origin, destination, trip time, or pickup radius information;
executing the client instructions on a rider client device to transmit a rider request;
executing the client instructions on a driver client device to transmit a driver offer;
matching a trip by executing server instructions to communicate a matched trip to the driver and the rider on the date of the travel after verifying that the rider and the driver accepted the trip;
facilitating negotiating a payment between the rider and the driver;
deducting a variable or fixed, base-fee from a rider or driver account based on the payment;
executing server instructions to transmit driver or rider identifying information including a photograph or a verified payment method to the client device;
executing client or server instructions to calculate route information from the origin to the destination;
executing client instructions to send map information including GPS map information containing route information to the display;
recording user trips;
and
executing client instructions that transmits feedback or user rating information to the server.
